(19) United States
(12) Patent Application Publication
(10) Pub. No.: US 2026/0297986 A1
(43) Pub. Date: Oct. 1, 2026

(54) VEHICLE COLLISION ACTIVATING ESCAPE DEVICE

(71) Applicant: Yung-Ming Yen, Tainan City (TW)

(72) Inventor: Yung-Ming Yen, Tainan City (TW)

(21) Appl. No.: 19/093,183

(22) Filed: Mar. 27, 2025

(51) Int. Cl. E05B 77/12

(52) U.S. Cl. CPC E05B 77/12

(57) ABSTRACT

A vehicle collision activating escape device includes a vehicle provided with at least one slide which connects a rotation disk pivotally mounted on the vehicle. An elastic member mounted between the rotation disk and the vehicle. The rotation disk connects a lock of the vehicle. Thus, when the vehicle decelerates suddenly during an accidental hit, the forward inertial momentum of the slide will pull the rotation disk which drives the lock to reach an unlocked state, so that the lock is unlocked automatically during the vehicle collision.

### BACKGROUND OF THE INVENTION

### Field of the Invention

The present invention relates to an escape device and, more particularly, to a vehicle collision activating escape device.

### Description of the Related Art

Current regulations require that vehicles should provide an automatic unlocking system that has an automatically unlocking function after a car accident to protect the safety of people in the car. However, the conventional automatic unlocking system usually has a complicated structure and may need to rely on electricity. Thus, there is a risk that the conventional automatic unlocking system may not operate normally when the power supply fails.

### BRIEF SUMMARY OF THE INVENTION

The primary objective of the present invention is to provide an escape device that is activated or unlocked automatically when vehicle collision or hit happens. Thus, the present invention provides a vehicle automatic unlocking device with a relatively simple and reliable structure.

In accordance with the present invention, there is provided a vehicle collision activating escape device comprising a vehicle and at least one unlocking module. The vehicle has a vehicle body provided with multiple opening and closing members. At least one of the opening and closing members is provided with a lock. At least one slide slot is formed in a predetermined position of the vehicle body or the at least one of the opening and closing members with the lock. The at least one unlocking module includes a rotation disk pivotally mounted on the at least one of the opening and closing members, an elastic member mounted between the rotation disk and the at least one of the opening and closing members, a slide mounted in the at least one slide slot, and a linking rope connecting the rotation disk and the slide. The rotation disk is connected with the lock of the at least one of the opening and closing members.

According to the principle of this invention, the slide has an inertia to slide forward during the normal braking process of the vehicle after the lock is locked. But the vehicle body is still disposed at a forward state, and the elastic member provides a resisting elastic force, so that the momentum of the slide cannot pull the rotation disk to a position where the lock can be unlocked. Thus, the lock is constantly kept at the locked state.

On the contrary, when a car accident or hit occurs, the vehicle body will suddenly decelerate. At this time, the inertial momentum of the slide will pull the linking rope which drives the rotation disk which is rotated to drive the lock which is activated to reach an unlocked state, so that the lock is unlocked automatically during the vehicle collision.

In comparison, the conventional automatic unlocking system has a complicated structure and may need to rely on electricity. The present invention uses a mechanical design to achieve the automatic unlocking function. Thus, the structure of the present invention is relatively simple and reliable to effectively improve the vehicle safety.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a schematic view of a vehicle collision activating escape device in accordance with the preferred embodiment of the present invention.

FIG. 2 is a locally enlarged view of FIG. 1.

FIG. 3 is a schematic operational view of FIG. 2 in use.

FIG. 4 is a schematic view showing the present invention is available for a bus.

### DETAILED DESCRIPTION OF THE INVENTION

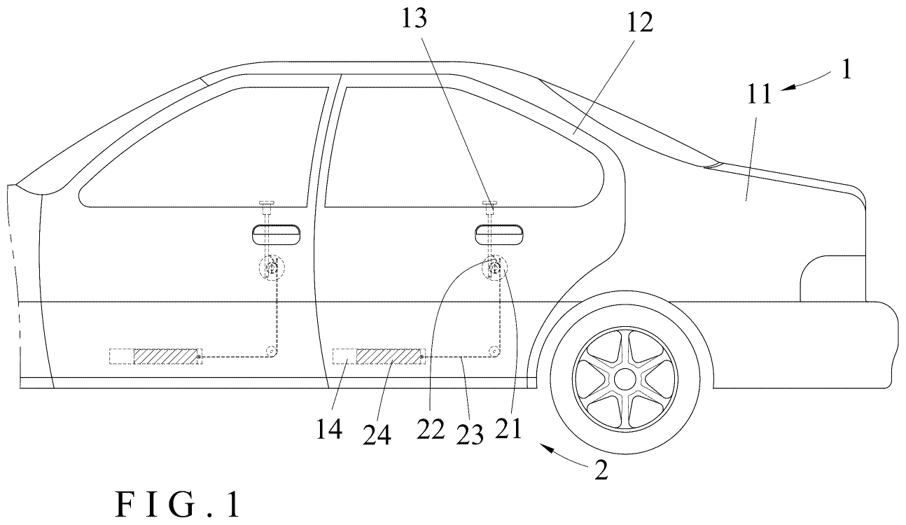

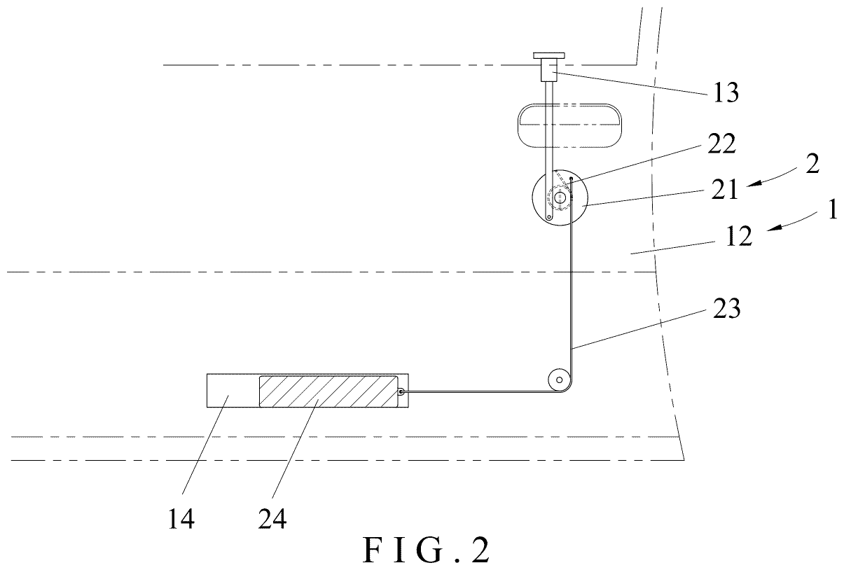

Referring to the drawings and initially to FIGS. 1 and 2, a vehicle collision activating escape device in accordance with the preferred embodiment of the present invention comprises a vehicle 1 and at least one unlocking module 2.

The vehicle 1 has a vehicle body 11 provided with multiple opening and closing members 12. At least one of the opening and closing members 12 is provided with a lock 13. At least one slide slot 14 is formed in a predetermined position of the vehicle body 11 or the at least one of the opening and closing members 12 with the lock 13.

The at least one unlocking module 2 includes a rotation disk (or turntable) 21 pivotally mounted on the at least one of the opening and closing members 12, an elastic member 22 mounted between the rotation disk 21 and the at least one of the opening and closing members 12, a slide (or slider) 24 mounted in the at least one slide slot 14, and a linking rope 23 connecting the rotation disk 21 and the slide 24. The rotation disk 21 is connected with the lock 13 of the at least one of the opening and closing members 12.

In the preferred embodiment of the present invention, the vehicle 1 is a bus or car.

In the preferred embodiment of the present invention, each of the opening and closing members 12 is a vehicle door, a safety door, a sunroof, or a trunk lid.

In the preferred embodiment of the present invention, the at least one slide slot 14 is formed in the vehicle body 11. Alternatively, the at least one slide slot 14 is formed in the at least one of the opening and closing members 12.

In the preferred embodiment of the present invention, the elastic member 22 is a torsion spring.

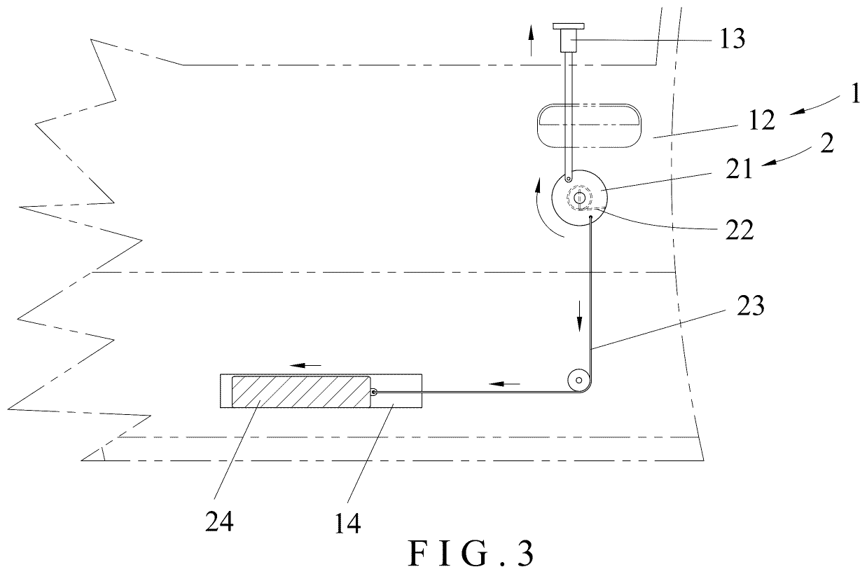

In operation, referring to FIGS. 2 and 3 with reference to FIG. 1, when a car accident or hit occurs, the vehicle body 11 will suddenly decelerate. At this time, the forward inertial momentum of the slide 24 will pull the linking rope 23 which drives the rotation disk 21 which is rotated to drive the lock 13 which is activated to reach an unlocked state as shown in FIG. 3, so that the lock 13 is unlocked automatically during the vehicle collision.

According to the principle of this invention, the slide 24 has an inertia to slide forward during the normal braking process of the vehicle 1 after the lock 13 is locked. But the vehicle body 11 is still disposed at a forward state, and the elastic member 22 provides a resisting elastic force, so that the momentum of the slide 24 cannot pull the rotation disk 21, or the slide 24 cannot pull the rotation disk 21 to a position where the lock 13 can be unlocked. Thus, the lock 13 is constantly kept at the locked state.

As shown in FIG. 1, the escape device of the present invention is available for a car.

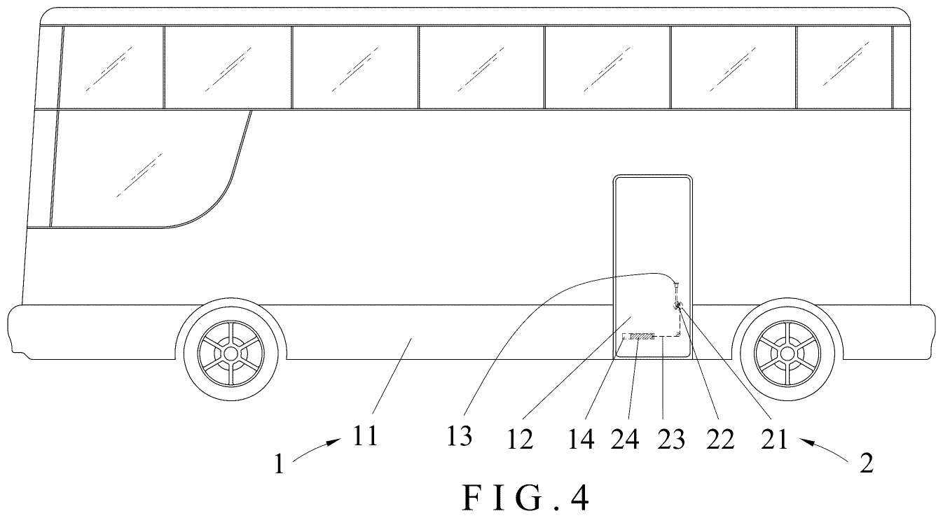

Referring to FIG. 4, the escape device of the present invention is available for a bus.

Accordingly, the present invention provides a vehicle automatic unlocking device with a relatively simple and reliable structure.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A vehicle collision activating escape device comprising:
a vehicle; and
at least one unlocking module;
wherein:
the vehicle has a vehicle body provided with multiple opening and closing members;
at least one of the opening and closing members is provided with a lock;
at least one slide slot is formed in a predetermined position of the vehicle body or the at least one of the opening and closing members with the lock;
the at least one unlocking module includes:
a rotation disk pivotally mounted on the at least one of the opening and closing members;
an elastic member mounted between the rotation disk and the at least one of the opening and closing members;
a slide mounted in the at least one slide slot;
and a linking rope connecting the rotation disk and the slide; and
the rotation disk is connected with the lock of the at least one of the opening and closing members.

2. The vehicle collision activating escape device as claimed in claim 1, wherein the vehicle is a bus or car.

3. The vehicle collision activating escape device as claimed in claim 1, wherein each of the opening and closing members is a vehicle door, a safety door, a sunroof, or a trunk lid.
